(19) United States
(12) Patent Application Publication
(10) Pub. No.: US 2018/0250837 A1
(43) Pub. Date: Sep. 6, 2018

(54) IMPROVEMENTS MADE TO A COMPACT SAFETY CUTTER

(71) Applicant: STARRETT INDÚSTRIA E COMÉRCIO LTDA, Pinheirinho - Itú - SP (BR)

(72) Inventor: Reinaldo DIAS BAPTISTA, Mangal - Sorocaba - SP (BR)

(21) Appl. No.: 15/736,754

(22) PCT Filed: Jun. 17, 2015
(86) PCT No.: PCT/BR2015/000091

§ 371 Date: May 30, 2018

(51) Int. Cl. B26B 1/08; B26B 5/00

(52) U.S. Cl. CPC B26B 1/08; B26B 5/003

(57) ABSTRACT

A safety box cutter is provided. The box cutter includes a handle including two hollow parts which are complementary to each other, wherein the outer surfaces of the two hollow parts are rubber coated. The box cutter also includes a trapezoid blade comprising a holding mechanism, wherein the holding mechanism includes a housing. The two hollow parts of the handle are configured to be mounted together to form a front opening and a space for the housing of the holding mechanism of a trapezoid blade. The housing of the holding mechanism of a trapezoid blade is formed of two hollow and complementary parts, and the two hollow and complementary parts of the housing are smaller than the handle. One of the hollow and complementary parts of the housing includes an outer wall that has an undercut area designed to accommodate a slider and a respective spring.

### TECHNICAL FIELD

This invention relates to improvements made to compact safety box cutter, more precisely, a box cutter of the type using trapezoid blade installed in a slider mechanism; the innovative box cutter blade holding mechanism is formed by a single piece with integrated slider and the blade is fixed to the sliding mechanism by magnet; the improved features are simplified constructively, maintaining total safety while handling the box cutter.

### TECHNICAL BACKGROUND

It is well-known that occupational safety is the set of technical, educational, medical and psychological measures used to prevent accidents, eliminating unsafe conditions in the workplace, whether by instructing or persuading people to use preventive practices.

Said security is a fundamental issue, especially for professionals who use cutting tools such as inventory handlers, shopkeepers, packers or other professionals who perform a range of tasks, such as cutting leather, tapestry or carpeting, opening packaging and odd jobs.

There are countless models of knife and box cutter on the market, of which, for the purposes of this report, several stand out such as portable and safety models, especially those developed for said activities, such as box cutters with a broad blade for cutting thick or resistant materials or those with a finer blade, used for cutting paper or fragile material.

Generally speaking, conventional safety box cutters are larger and are formed by a rubberized grip and the self-retracting system coupled to the blade allows it to be exposed during cutting and after performing the operation, the blade can be withdrawn into the body of the box cutter manually or automatically retract, protecting the user from injury during cutting. Example of this type of box cutter can be seen in documents of the type US2010043235 (HAO WEN) or U.S. Pat. No. 4,635,309 (LARSEN).

Although this type of safety box cutter is provided with mechanisms for retracting the blade; they do not ensure full safety for users, as the return of the blade is not automatic.

A safety box cutter model with automatic retractable mechanism can be seen in the US document No. U.S. Pat. No. 8,549,755 (STANLEY). This document deals with a compact box cutter including a sliding blade holding mechanism attached to a handle. A trapezoid blade is mounted detachably to the blade holding mechanism by means of a blade closing mechanism. A sliding locking mechanism selectively retains the blade holding mechanism in its extended or retracted position relative to the handle. When the blade holding mechanism is extended, the blade holding mechanism and most of the blade extend beyond the end point of the handle. This manual sliding blade holding mechanism significantly increases the full length of the knife so that it remains comfortable to use in the extended position and, when the holding mechanism is automatically retracted or withdrawn, the knife remains longitudinally compact. An opening in the front portion of the handle creates a gap between the blade and the handle to discourage the transfer of debris from blade to handle when the blade is retracted.

While this model of box cutter contains improvements through the sliding blade holding mechanism with automatic retraction, said box cutter has complex constructive features, especially through by the inclusion of a sliding locking mechanism that selectively retains the blade holding mechanism in its extended or retracted position relative to the handle.

Other documents found in specialized databases show other models of safety box cutters, such as document No. U.S. Pat. No. 8,028,420 (MERIDIAN), which is a box cutter in which the parts for replacing the blade are may be moved inside and outside of the knife handle through a unique rail system. The blade is secured by a series of elastic metal parts, one of which contains a projection on a metal guide rail.

Document No. US 2010/0325899 (PRETT et al.) Refers to a retractable box cutter comprising a handle and a blade with an upper edge, lower edge, first side edge and second side edge. The box cutter has a blade holding mechanism with a locking assembly keeping the blade within the blade holding mechanism; the closing assembly is movable between a blade locking position and a blade releasing position; the closing assembly includes a locking element that engages the first side edge in the blade locking position.

The documents cited in the above paragraphs, although belonging to the same field as the application, that is, safety box cutters with devices for advancing and withdrawing the blade holding mechanism or holder and blades that slide within the blade holder at the push of a side or top-mounted button do not present any of the characteristics of the object improved herein, thus ensuring that it meets the legal requirements of patentability.

### PURPOSES OF THE INVENTION

Aiming to introduce improvements to the consumer market, the applicant has developed improvements made to compact safety box cutter of the type used in operational works requiring cutting tools. The box cutter in question comprises a main handle formed by two hollow and complementary parts, with rubber-coated external surfaces; said handle is capable of containing a housing for a trapezoid blade holding mechanism which slides longitudinally within said handle by activating a slider which, in turn, is subject to a return spring duly anchored in the inner part of the handle.

Said slider of the blade holding mechanism housing is mounted in a displacement channel located on one of the side faces of the handle. This channel has stops in the form of gaps in the upper and lower walls of the channel, sized to accommodate the small protruding teeth of the upper and lower faces of the slider. The gaps in the lateral channel of the handle to move the slider are responsible for the positioning of the blade holder, in other words, in the retracted or extended position.

Thus, to retract or extend the blade holding mechanism housing relative to the handle, all the user needs to do is press the slider into the handle by pressing a small spring, described in more detail later, so that the teeth disengage from the rest position in the lateral channel gaps, making handling of the blade holding mechanism safe and practical.

Another improvement included in the novel box cutter consists of including a blade holding mechanism which is formed of a single blade piece with an integrated slider in the upper part. This blade is made of flexible, plastic material. The upper portion of the blade includes said slider and a projecting member in the shape of a thin rod with an enlarged free end, especially sized to slide into a slot formed in the upper edge of the blade holding mechanism housing.

Said blade holding mechanism incorporates at least one magnetic part, designed to hold the trapezoid blade, making it possible to position it, as well as replacement of the blade, if necessary, safe and practical.

Another improvement relates to the automatic return spring in the blade holding mechanism and consequently automatic return of the trapezoid blade as soon as the user stops pushing the blade holding mechanism slider during cutting use. The free end of the return spring engages the blade holding mechanism while the opposite end is anchored in a projection on the inner face of the blade holding mechanism housing.

Thus, when the user releases the slider in the blade holding mechanism, it is automatically drawn back into the housing, ensuring the trapezoid blade is stored when the box cutter is not in use.

Thus, the advantages of the innovative box cutter can be listed as:
Blade holding mechanism in one single piece;
Blade slider integrated into the holding mechanism;
Fixing the blade in the holding mechanism by means of a magnetic part;
Inclusion of a return spring to automatically return the blade holding mechanism into the holder housing; and
the construction of the thin rod ensures stability and wide travel of the blade holding mechanism and its respective trapezoid blade relative to the end of the handle.

### DESCRIPTION OF THE FIGURES

Complementing this description in order to obtain a better understanding of the features of the invention and according to a preferred practical embodiment thereof, accompanying the attached description is a set of drawings, in which its operation is shown, in an exemplified, although non-limiting manner:

FIG. 1 shows an exploded perspective view of the elements that make up the novel safety box cutter;

FIG. 2 shows a perspective view illustrating the blade holder housing and an exploded view of the parts of the handle;

FIG. 3 shows an exploded perspective view of a portion of the slider handle and the blade holding mechanisms housing illustrating the resting points of the teeth projecting from the slider device;

FIG. 3A shows a cross-section of the slider assembly in the resting point;

FIG. 4 shows an assembled perspective view of the box cutter;

FIG. 4A shows a birds-eye view of the safety box cutter;

FIGS. 5 and 5A show side views of the box cutter devoid of one of the parts composing the handle in order to visualize the extension of the blade holder mechanism housing; and

FIGS. 6 and 6A show side views of the box cutter devoid of one of the parts comprising the handle illustrating the blade holding mechanism housing, also, devoid of one of the parts in order to view of the extension of the blade holding mechanism.

### DETAILED DESCRIPTION OF THE OBJECT

Referring to the drawings, this invention relates to “IMPROVEMENTS MADE TO COMPACT SAFETY BOX CUTTER”, more precisely it is a safety box cutter (1) of the type used by professionals who make use of cutting tools for various operations, such as, opening boxes, cutting leather, tapestry, etc. Said box cutter (1) is formed by a handle (2) configured by two hollow parts (2A) and (2B) complementary to each other, the outer surfaces (2c) of which have a rubber coating. Said parts (2A)/(2B) when mounted together form a front opening (ab1) and a space for the housing (3) of the holding mechanism (4) of a trapezoid blade (LM); said housing (3) also formed by two hollow and complementary parts (3A) and (3B) which are smaller than the handle (2). The housing (3) includes, in the outer wall (3a1), an undercut area (3a2) designed to accommodate a slider (5) and respective spring (8).

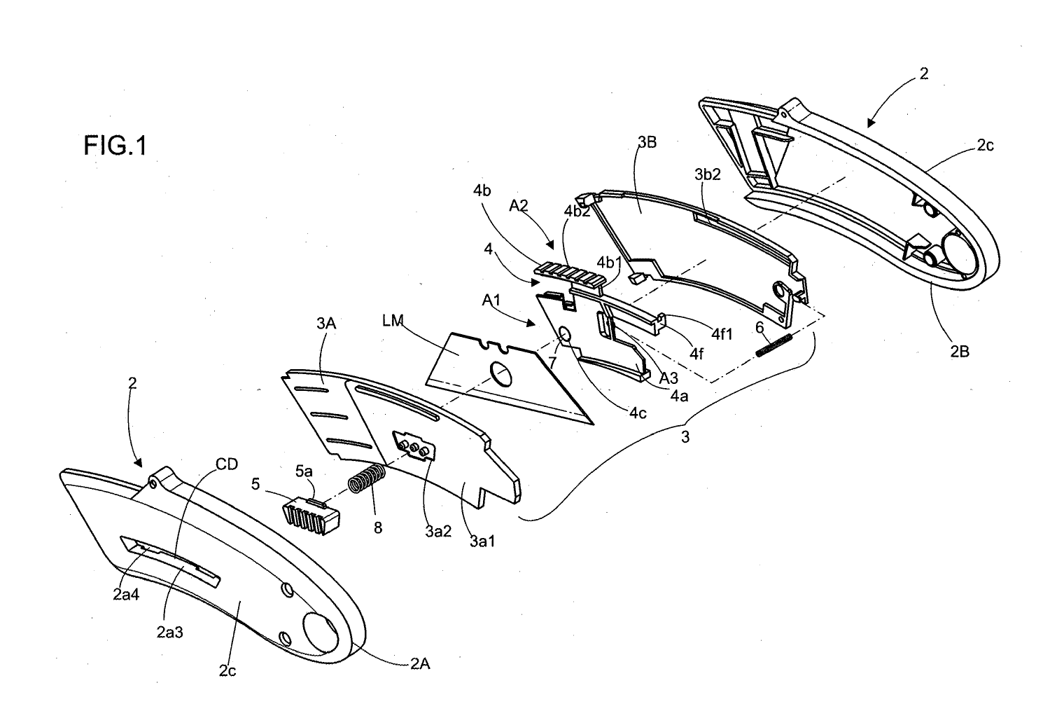

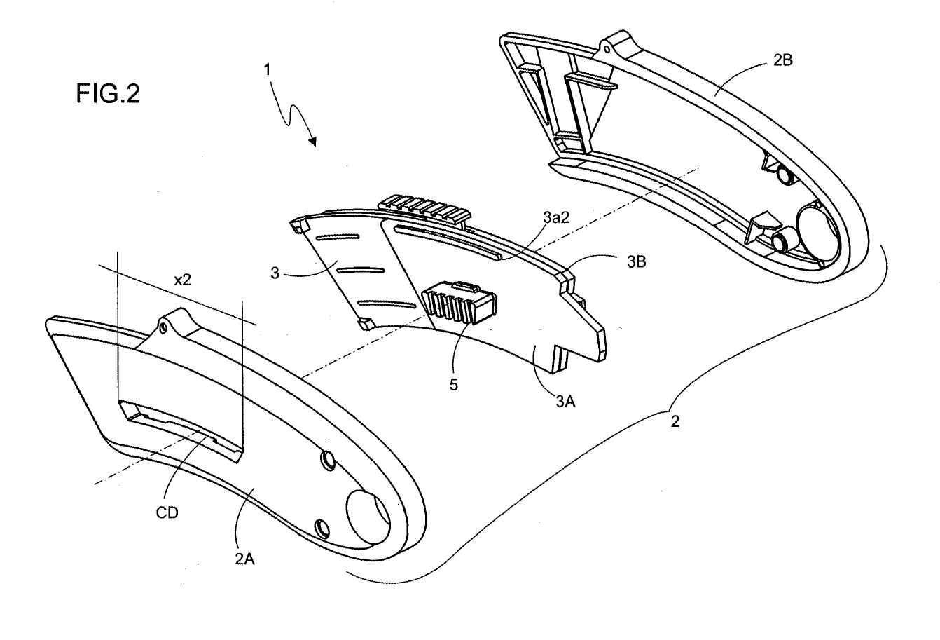

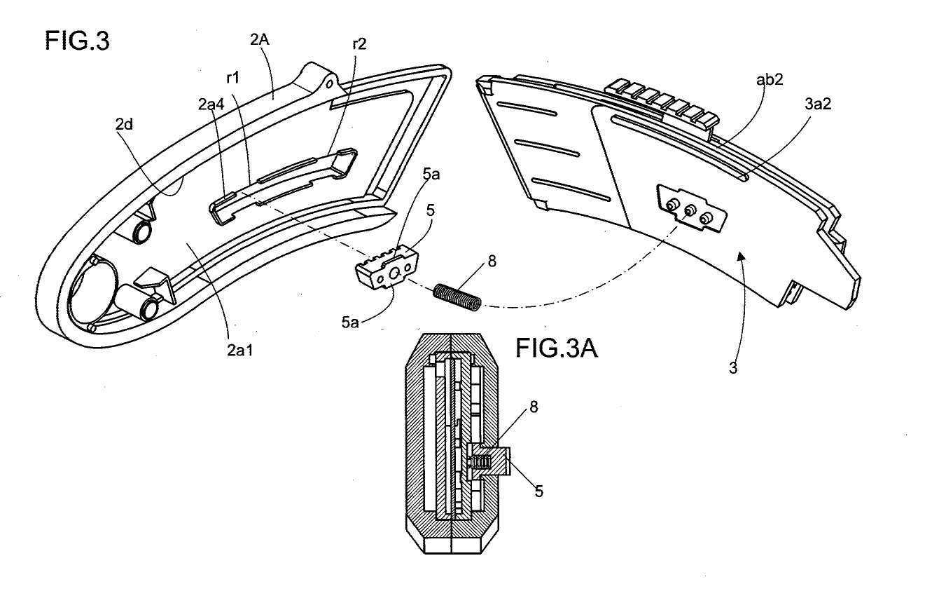

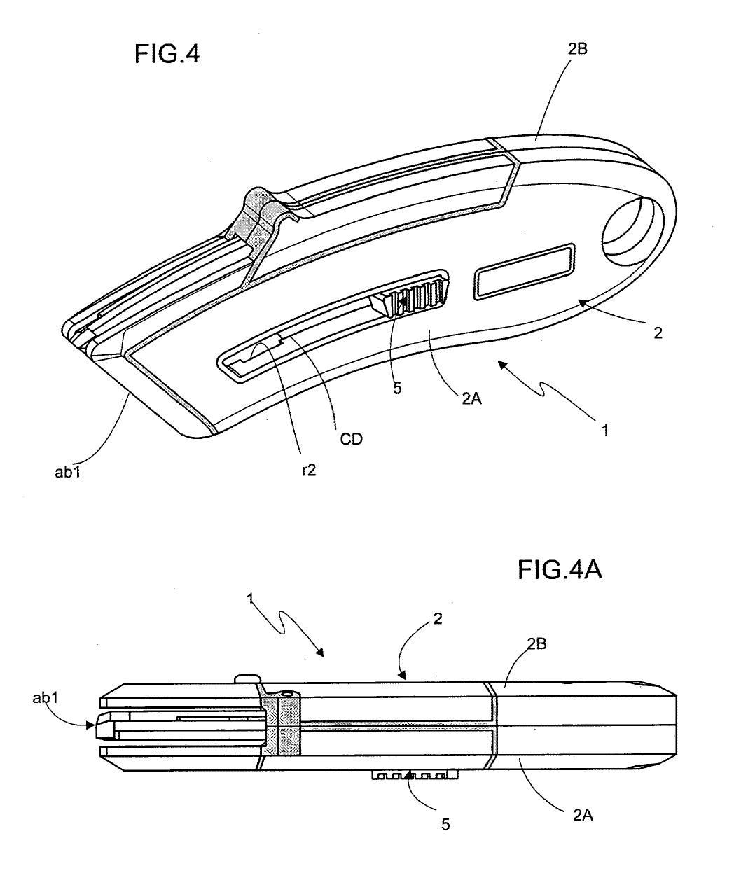

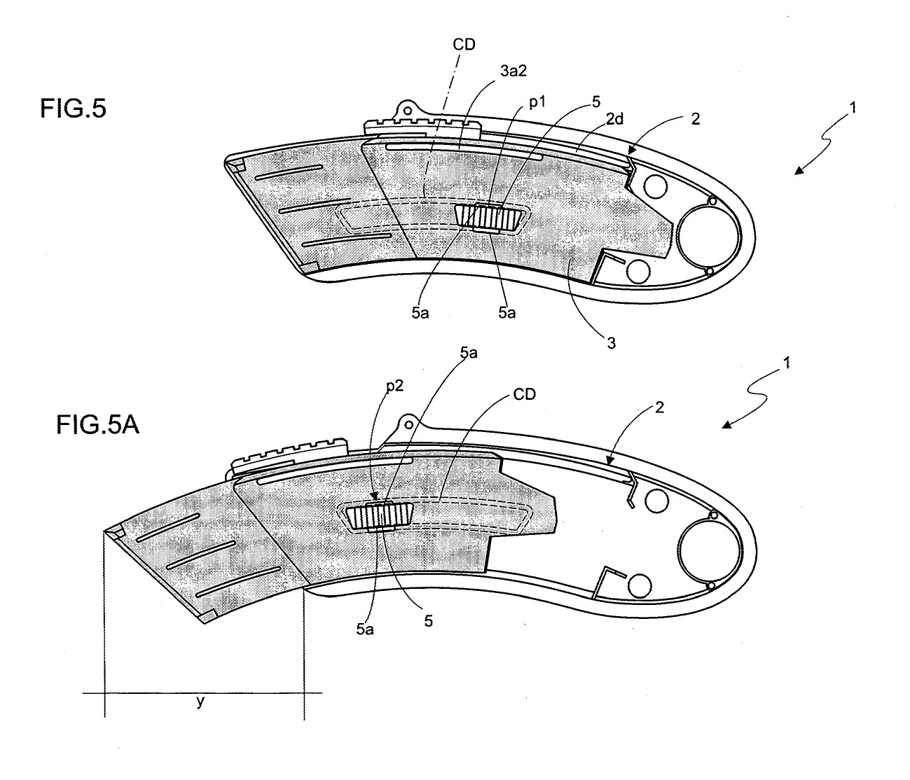

According to the present invention, said housing (3) (see FIG. 1) contains, on the same external wall (3a1) of part (3A) a guide (3a2) configured by an oblong projection which slides on an orthogonal wall (2d) on the inner face (2a1) of part (2A), which, in turn, has an elongate gap (2a3) from which orthogonal peripheral walls (2a4) are formed so as to form the displacement channel (CD) for the slider (5). Said channel (CD) walls (2a4) have pairs of gaps (r1) and (r2) placed close to the ends of the channel (CD) in order to configure end of movement (p1) and (p2) of projecting teeth (5a), on the slider (5); point (p1) corresponds to the position of the housing (3) retracted within the handle (2) and point (p2) corresponds to the position of the housing (3) extended at (y) in relation to opening (ab1) of the handle (2). The length (x2) (see FIG. 2) of the slider displacement channel (5) defines the extension (y) (see FIGS. 5 and 5A) of the housing (3) relative to the opening (ab1) of the handle (2).

Said housing (4) of the trapezoid blade (LM) (see FIG. 1) is formed in a thin single piece (4a) and branches at the end (4f) with a guide tooth (4f1) which slides into the slot (3b2) in the part (3B) of the housing (3).

Said housing (4) (see FIG. 1) is divided into three distinct areas, namely: i) blade (LM) receiving area (A1); ii) integrated slider area (A2); iii) area (A3) for anchoring the automatic blade (LM) return spring (6). Said integrated slider area (A2) is installed in opening (ab2) of housing (3) and is formed by the association of gaps in the upper edges of parts (3A)/(3B).

Blade (LM) receiving area (A1) comprises an undercut (4c) forming a cradle for the assembly of at least one magnet (7) by configuring a magnetic field to attract the blade (LM) and, consequently, the housing mounting (4).

In a preferential constructional version, the integrated slider area (A2), provided in the blade (LM) holding mechanism (4), comprises a projecting and flexible member (4b), cross-sectional, preferably T-shaped, from the top face of the single piece (4), the orthogonal portion (4b1) sliding into opening (ab2), while the outer surface of the flat portion (4b2) has multiple gaps.

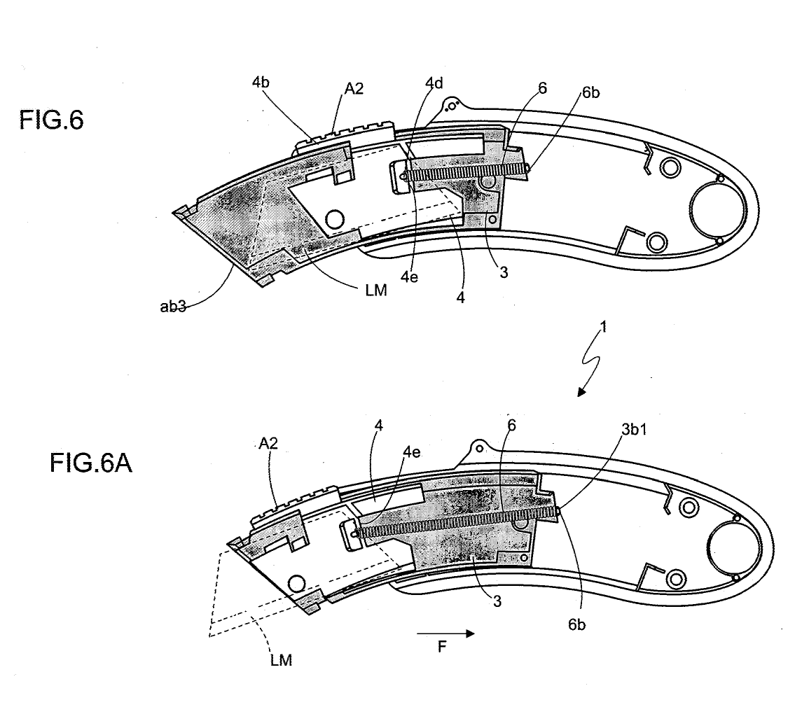

Said area (A3) anchoring the spring (6) (see FIGS. 6 and 6A) of the automatic blade (LM) return is configured by a rotating and inverted “L” shaped tooth (4d) which is developed from the flat face of a thin wall (4e) in a gap in the central portion of the part (4). The opposite end (6b) of the spring (6) engages a tooth (3b1) of part (3B) and is located at the opposite end of the opening (ab3) of the housing (3) of the blade (LM) holding mechanism (4).

Thus, when the user releases integrated slider (A2) from the blade (LM) holding mechanism (4) the force (F) spring (6) automatically retracts, dragging the blade holding mechanism (4) to the inner portion of the housing (3), ensuring the blade is stored when the box cutter is not in use.

There is no doubt that when this invention is put into practice, modifications may be made with respect to certain details of construction and shape, without this implying departure from the fundamental principles which are clearly substantiated in the context of claim, it being understood that the terminology used was not intended to be limiting.

1) A safety box cutter comprising:
a handle comprising two hollow parts which are complementary to each other, wherein outer surfaces of the two hollow parts are rubber coated;
a trapezoid blade comprising a holding mechanism, wherein the holding mechanism comprises a housing;
wherein the two hollow parts of the handle; are configured to be mounted together to form a front opening and a space for the housing of the holding mechanism of a trapezoid blade,
wherein the housing of the holding mechanism of a trapezoid blade is formed of two hollow and complementary parts, wherein the two hollow and complementary parts of the housing are smaller than the handle,
wherein at least one of the two hollow and complementary parts of the housing comprises an outer wall, the outer wall comprising an undercut area designed to accommodate a slider and a respective spring,
wherein the outer wall comprises a guide configured by an oblong projection which slides on an orthogonal wall on an inner face of at least one of the two hollow parts of the handle,
wherein the at least one of the two hollow arts of the handle comprises an elongate gap from which orthogonal peripheral walls are formed so as to form a displacement channel for the slide,
wherein the holding mechanism of the trapezoid blade comprises a component with a branch at a distal end of the component, wherein the branch comprises a guide tooth configured to slide into a slot in at least one of the two hollow and complementary parts of the housing,
wherein the holding mechanism comprises a blade receiving area, an integrated slider area, and an area for anchoring a return spring of the blade,
wherein the integrated slider area is installed in an opening of the housing and is formed by the association of gaps in the upper edges of the two hollow and complementary parts of the housing,
wherein the blade receiving area comprises an undercut forming a cradle for at least one magnet configured to secure the blade through magnetic attraction and the housing mounting.

2) The safety box cutter of claim 1, wherein the integrated slider area, provided in the blade holding mechanism comprises a projecting and flexible member comprising an orthogonal portion and a flat portion, wherein the orthogonal portion is configured to slide into the opening of the housing, and wherein an outer surface of the flat portion comprises a plurality of gaps.

3) The safety box cutter of claim 1, wherein the area for anchoring the return spring of the blade is configured by a rotating and inverted L shaped tooth, wherein the L-shaped tooth is developed from a flat face of a thin wall in a gap in a central portion of the holding mechanism
wherein a distal end of the return spring engages a tooth of at least one of the two hollow and complementary parts of the housing and is located at a second opening of the housing.

4) The safety box cutter of claim 1, wherein the orthogonal peripheral walls comprises at least two gaps positioned towards distal and proximal ends of the displacement channel to confine movement of projecting teeth on the slider between two points,
wherein at least one of the two points corresponds to the position of the housing retracted within the handle, and wherein a second of the at least two points corresponds to the position of the housing extended towards the front opening of the handle.

5) The safety box cutter of claim 1, wherein a length of the displacement channel defines an extension of housing in relation to the front opening of the handle.

6) The safety box cutter of claim 1, wherein a manual release of the slider coupled with the spring which automatically retracts when the box cutter is not in use is configured to position the holding mechanism into the housing.
